(19) United States
(12) Patent Application Publication
(10) Pub. No.: US 2016/0042623 A1
(43) Pub. Date: Feb. 11, 2016

(54) Patient Monitoring System

(71) Applicants: Sherry Riley, East Hampstead, NH (US); Joan Romboli, Manchester, NH (US)

(72) Inventors: Sherry Riley, East Hampstead, NH (US); Joan Romboli, Manchester, NH (US)

(21) Appl. No.: 14/454,949

(22) Filed: Aug. 8, 2014

(51) Int. Cl. G08B 21/02

(52) U.S. Cl. CPC G08B 21/02

(57) ABSTRACT

A computerized patient monitoring and alerting device and system. The alerting device is in wireless communication with a centralized server that stores patient data and communicates alarms, updates, status, deadlines, and the like to the device. The alerting device may also be used to record patient data which is sent and stored on the centralized server.

### BACKGROUND OF THE INVENTION

1. Field of the Invention

The present invention relates generally to medical patient monitoring systems. More particularly the present invention relates to a device and system for use by nurses and other patient monitoring staff that provides a touch screen device integratable with a hospital computer system for effectively monitoring patients, updating patient data, and the like.

2. Description of Related Art

In hospital environments, doctors, nurses, and other staff are assigned certain patients in an area of the hospital. Tracking all of these patients and their needs can be a difficult task. Moreover, if the patients are not all kept track of, the consequences can be dire.

Often in hospital environments, a plethora of audible alarms are used to alert nearby staff of different issues that may come up with a patient. Generally it is very difficult to distinguish the different alarms, and all sound like they are emergency alarms. This can lead to an environment where the alarms create a cacophony, leading to “alarm fatigue” where the doctors, nurses, and staff tune out alarms and do not adequately respond to them. Therefore, the need exists for a system to allow doctors, nurses, and hospital staff to track patient needs without constant audible alarms.

In addition to the issues with alarms, it is also often difficult for a busy doctor, nurse, or staff to keep up good records when running back and forth from patient to patient. Therefore, the need exists for a device that may allow quick, easy and mobile record keeping in a hospital environment.

Therefore, what is needed is a device that may track patient needs, allow mobile record keeping, and to provide a number of other communications functions to allow hospital workers to maximize their efficiency while also maximizing patient safety.

### SUMMARY OF THE INVENTION

The subject matter of this application may involve, in some cases, interrelated products, alternative solutions to a particular problem, and/or a plurality of different uses of a single system or article.

In one aspect, a medical patient monitoring system is provided. The system comprises a computerized alerting device having a processor, a memory, a vibrating mechanism, a touch-screen display, and a battery providing power to the device. The system further comprises a centralized server in wireless communication with the alerting device. The communication between the server and device may instruct the alerting device when and how to alert a user. The alerting is preferably carried out by a vibrating and/or a flashing on the touch-screen display.

The system further comprises a headset in wireless communication with the computerized alerting device. The headset may provide audible communication between the user and one of a patient and a hospital staff member, among other functions. The headset may also provide communication between the alerting device and the user by providing an audio input into the user's ear and recording the user's voice.

The alerting device is configured such that it may provide a non-audible alarm alerting the user of an upcoming task or current action. Additionally, the touch-screen display is capable of providing a visual alert on at least one of a cardiac monitor alarm, a bed alarm, a chair alarm, a patient call alarm, an elopement alarm, and a nurse reminder alarm, the visual alerts being activated based on a data communicated from either the centralized server or directly from a patient monitor. These alarms may be signaled by one or a plurality of patient monitor devices to which the patient is monitored by, either by a connection, analytic sensing, or other direct or indirect monitoring.

In another aspect, a method of using the medical patient monitoring system is provided. The method may begin with the step of inputting a user ID into the alerting device to identify the user. The user may then attach the alerting device to a garment that they are wearing, or may strap or otherwise attach it to their bodies. The alerting device may wirelessly communicate to the centralized server based on the user ID of the user. The centralized server may in turn transmit data comprising a plurality of rooms assigned to the user and a plurality of assignments for each room to the alerting device. As an alert comes up for a patient, the alerting device may provide an alert to the user. This alert may be a flashing, a vibrating, a combination of the two, and the like. Preferably the alert may be non-audible, at least initially. Upon acting on this alert, the alerting device may receive an input by the user confirming that the action has been performed. Upon receiving this input, the alerting device may transmit a confirmation to the centralized server, which may be recorded in the patient file.

### BRIEF DESCRIPTION OF THE DRAWINGS

FIG. 1 provides a detail view of an embodiment of information provided by a display of the device.

FIG. 2 provides an embodiment of a headset in electronic communication with the device of the present invention.

FIG. 3 provides a flow chart of information flow through an embodiment of a system of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a computerized patient monitoring and alerting device and system. The device is in wireless communication with a centralized server that stores patient data and communicates alarms, updates, status, deadlines, and the like to the device. In one embodiment, computerized device may be configured to utilize voice recognition to assist in documentation and patient updates.

In another embodiment, the device of the present invention may be an alerting device configured to vibrate and/or blink to alert an update. In this embodiment, an audible alarm will only sound in an emergency situation. Examples of emergency situations include cases where a patient is in a life threatening situation and could die if not acted on immediately, a failure to respond to a non-audible alarm within a designated time frame, and the like. This alerting device configuration may aid in limiting “alarm fatigue” experienced by nurses and other staff caused by an overwhelming amount of alarms that are not actual emergencies.

The term non-audible alarm is used herein to refer to alarms that operate primarily in a non-audible manner and do not use sound as a means to alert. Generally, the non-audible alarm refers to a vibrating or a flashing. While vibrating may make a slight noise when activated, its primary alerting function is the tactile alerting, therefore it applies as a non-audible alarm.

The alerting device of the system contemplated herein is a computerized device having a processor, memory, storage, and a display. The device further has a wireless communications ability allowing it to be in wireless electronic communication with a server, network, patient monitor, and the like. This communications ability may allow a user to communicate directly with not only the staff in their immediate unit, but also staff in other units and departments. Moreover, the device may comprise a non-transitory computer readable medium comprising programmed instruction sets allowing the processor and other device elements to execute or otherwise perform various functions of the device and system described herein. It is further important to note that, because cellular telephones are prohibited for hospital workers in most situations, the alerting device of the present invention will not be a cellular phone or “smartphone”.

In one embodiment, the device may comprise a scanner such as a camera or barcode scanner. The scanner may allow a nurse or the like to scan in medicine, supplies, and the like to automatically record its administration, use, application, removal, and the like. The alerting device may then assign information to the scanned image including patient identification, timestamp, notes, and the like.

The scanner may further be used in any situation a barcode is present in a hospital or similar embodiment for tracking purposes. For example, a patient may have a barcode assigned to them. In this case, the patient barcode may be scanned, and then a medicine to be administered may be scanned. The alerting device may then send the scanned information to the centralized server for confirmation. Upon receipt of confirmation, the medicine may be administered and upon inputting an administration confirmation into the alerting device, it may automatically send data to the server for storing in the patient file with information about time administered, quantity, medicine, notes, and the like. In further embodiments, the server may access a medicine cost data and automatically add the cost of the medicine administered to the patient's bill. This automatic tracking of billing may be applied automatically to all other treatments as well that may have costs assigned to them. Upon being reported on by the alerting device and transmitted to the centralized server, the system may automatically assign costs to the patient's bill.

In a further embodiment after the alerting device transmits the scanned patient barcode and medicine barcode to the centralized server, before administration, the centralized server may be configured to perform an allergy and interaction check. This allergy and interaction check is based on a comparison of the patient file and scanned medication by the centralized server, wherein the centralized server compares the medicine to a list of medicines that the patient file identifies as being a potential allergy risk or interaction risk. This check may compare listed allergies in the patient file. It may also cross reference the medicine scanned with previously administered medicines in the patient file and checks them for known interactions. Further still, the checking may involve checking the medicine dosage compared to previous dosages to confirm that an overdose is not administered.

In a further embodiment, the device may have a built-in translation software to aid in communications across languages.

A headset, headphones, or other audio communications device may be connectable to the device (collectively referred to as a headset). The audio communications device preferably is personal, such as a headset to allow communications only with the user, and to limit noise.

Some embodiments of the device may have a camera. The camera may allow a user to take photos of a patient's status, wounds, abnormalities, environment and the like. The device may be configured so that the camera takes a photo and the photo may be configured to automatically be assigned to the patient's file along with other information such as a timestamp, notes and so on, and automatically sent to the server. Additionally, notes may be added to the photo for tracking, record keeping, and the like. A time stamp and location data may be automatically assigned to the photo and stored on the server.

In yet another embodiment, the alerting device may allow for direct nurse (or other staff) to patient communication. In this embodiment, the alerting device may receive a non-audible call signal alert (likely presented as a flashing light, symbols on a display, or vibration). The monitor may then activate a communication feature and respond directly via text messaging, video conferencing, audio communication, and the like. A headset or other hands-free communication device may be utilized in this embodiment.

Examples of specific color codes and symbols may include: a blue heart to indicate a cardiac monitor alarm, a red light with a bed symbol to indicate a bed alarm, a yellow light with a chair symbol to indicate a chair alarm, a green light with a person symbol to indicate a patient call alarm, an orange light to indicate an elopement alarm or neonate abduction, a white light with a star symbol to indicate a reminder alarm for the user—which may be touch sensitive to display the particular action the alarm is reminding for.

In a particular embodiment, the device and/or headset may have a vibrating alarm that may vibrate if it is taken from the hospital or hospital unit after the user has logged out from his/her shift.

In embodiments where multiple staff members are assigned to a single room, a plurality of alerting devices may all be in communication with the centralized server. As such, if an alarm goes off, the multiple staff members will each receive the alarm. Once one of the staff members addresses the alarm, it may be deactivated for all staff monitoring the room. However, if additional help is needed by the addressing staff member, direct communication features of the alerting devices may be used to directly request one or all of the monitoring staff's assistance.

Generally, the present invention will include at least a touch-screen on the alerting device. In many cases, the invention will also include a headset having a wireless communication with the device, along with an ear-piece and microphone. All elements of the device are configured to be particularly adaptable for hospital and similar patient care environments. In varying embodiments, the invention may have at least one of the following advantageous features: waterproof, washable, having an anti-microbial surface or surfaces, lightweight, compact, may utilize easily recognizable icons, and may have rechargeable batteries.

As designed, the present invention provides a number of services and advantages over the prior art. One advantage is that by limiting audible alarms to emergencies, and using non-audible alarms such as vibrations and flashing lights to alert for less urgent emergencies, the device limits “alarm fatigue” by nurses and other staff. Alarm fatigue results from a hospital worker being continually exposed to noisy alarms. Often it is difficult to determine by the alarm sound the urgency of the alarm. Eventually, the worker will tune this out, and may miss a very urgent alarm. The present invention prioritizes alarms and helps the user respond to the alarms and other actions in a proper and efficient order.

Further, the device, by vibrating and flashing, will limit the noise level in the hospital environment, bringing a benefit to both the workers and patients.

Moreover, the present invention will decrease medication errors by providing alerts for reminders of medications. For example, reminders 30 minutes before the ordered time and an alert at the time for administration. Further still, medications may be scanned directly into the device, and the device may provide a confirmation that the scanned medicine is correct and confirm administration. Further, the scanning may provide a computer generated record of medicine administered. It should be understood that the alerting device may be configured to prompt (visually, audibly, tactilely, etc.) a user to carry out certain tasks and in a certain order to ensure proper procedures. For example, medicine administered may be scanned, patient barcode may be scanned, administered, confirmed, and the like, all in a proper order as prompted by the alerting device. This prompting may be stored on a memory of the alerting device, and/or the alerting device may be instructed by the centralized server, and a communication between the two may instruct the alerting device.

Additionally, the present invention may allow better tracking of staff performance because response times, administration times, observations, notes and the like will all be traceable and time stamped. Accordingly this may even lead to a reduced need for hospital inspections, and less invasive hospital inspections.

Further still, the present invention will greatly enhance point of care documentation because of its integration and communication with a central documents server. Document information regarding a patient can be input into the device via, for example, the touch screen, camera, scanner, audio recording, and the like. This recorded information may be automatically and immediately sent to the central server, and may be accessible by others such as other caregivers, staff, and the like using other alerting devices or another computer in communication with the server. Further, because the device can be used to input documentation, notes, records and the like at the point of care (as opposed to after the fact at a computer station away from the patient) errors are omitted that can be caused by forgetting, by a worker getting distracted by another event, and the like. Similarly, the alerting device may eliminate the need to wheel in a mobile workstation because it will provide all functionality that such workstations provide, in a compact and mobile interface.

Yet further, the present invention may result in increased patient satisfaction resulting from the better environment and care. It may limit loss of supplies, medications, and the like, to lower a hospital's cost. The device may additionally increase a productivity of the staff by any number of the reasons listed above.

In a further embodiment, the device may have a memory backup system that may be utilized at times, and may be particularly useful in an offline operation embodiment. In this embodiment, data may be continually recorded from the server in the event that the connection to the centralized server is lost. If the connection is lost, the data regarding upcoming alarms will be stored in the memory. Further, data may be input to the device as it would normally be, and instead of being sent to the central server, will be stored in the memory of the device. Once a connection is re-established, the device may automatically transfer the stored data to the server.

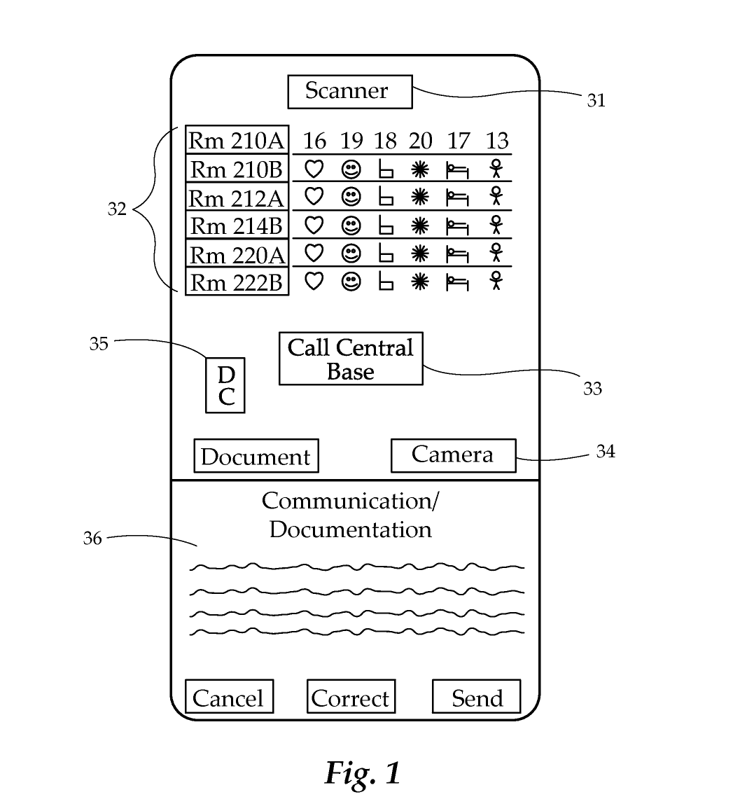

Turning now to FIG. 1, an embodiment of the device is provided. In this view, the device is displaying a plurality of information sections that may be interacted with via the touch screen of the device. For example, a scanner button 31 may activate a scanner to input information such as barcodes, and the like. Once activated, the scanner may receive the information and the device may be automatically configured to store this information in its appropriate location, either on a server or on the device. This information may further be associated with the patient or room number to which it corresponds to.

The device further displays a tracking list 32 of actions for the user. The tracking list is displayed on the screen and comprises plurality of rooms assigned to the user, as well as a list of either current or upcoming actions for each room, and if applicable, alarms for the room. In this case, and for illustration, a number of alarm alerts are shown: A cardiac monitor alarm 16, a bed alarm 17, a chair alarm 18, a patient call alarm 19, nurse reminder alarm 20, and elopement alarm 13. It should be understood that other alarms may be used as well and the alerts shown are for illustration and non-limiting. Further, it would be very unusual for each alarm to be on all at the same time, and these alarms are only provided as exemplary.

Upon a touching of the touch screen on the room number, the device may be configured to display any and all of the patient information, including all information that may be on the patient's medical chart (culture, religion, diagnoses, schedule, history, current medication, allergies, sensitivities, and the like), an updated schedule, and the like. As such, the device may allow the user to get all available information on the patient in the particular room number. Further still, the system, and particularly the alerting device provides access to every body system and area of the patient.

The room list 32 may be in any order, and in some embodiments, may be re-ordered depending on priority. In some embodiments, more information can be received such as details on the action required by touching an area over and around the room row. The device may further be configured to call a central base of the hospital or unit via touch screen button 33. This function will provide direct phone conversation with a central base operator to the user.

A direct communication touch screen button 35 may provide direct communication with a patient in a particular room assigned to the user. In another embodiment, the direct communication touch screen button 35 may provide direct communication with other coworkers or staff of the user.

A camera touch screen button 34 may operate to activate a camera of the device. In some embodiments, the scanner and camera may be the same camera utilized by a different software application of the device 10 or the same software in a different manner. In this view, a camera button 34 may activate a camera to record input information such as photographs, and the like. Once activated, the camera may record the information and the device 10 may be automatically configured to store it to its appropriate location and associated with the patient or room number to which it belongs.

The device is further configured to allow direct input of documentation 36 regarding a room or case the user is working on. This may be achieved by a keyboard and text input field, a voice recognition field, and the like. Once the documentation 36 is recorded, the device 10 may automatically assign it to the room or patient data to which it applies either on the central server, device memory, or both.

The direct communication contemplated herein may be performed in any manner. In one embodiment the communication involves activating a direct communication feature of the alerting device, allowing verbal communication with a patient. This communication may involve both receiving an audio from the user by the headset and transmitting a signal based on the received audio from the headset to the alerting device. The alerting device will then send a signal to the initial sender.

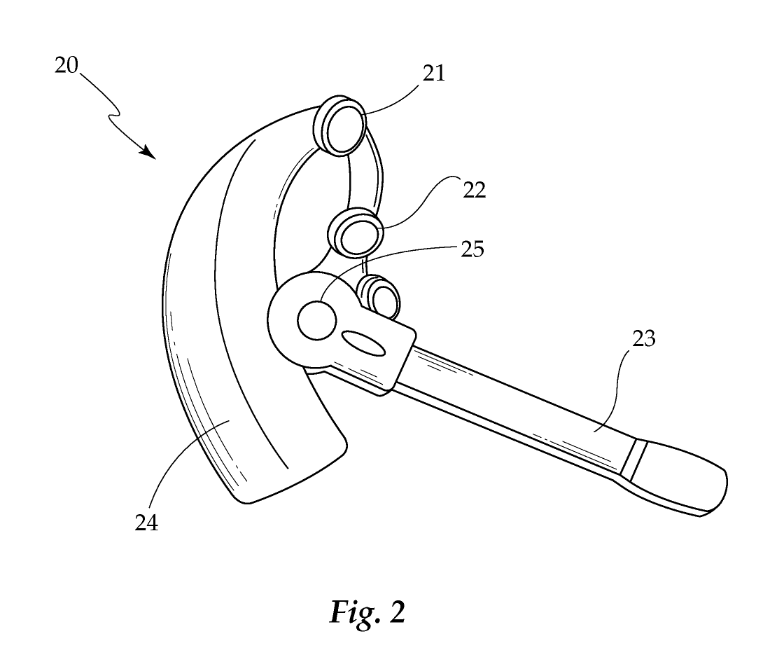

FIG. 2 shows an embodiment of a headset of the present invention. The headset 20 is configured to be in communication with the device 10 (of FIG. 1). This communication may be wireless, and in many cases is a Bluetooth (i) or similar wireless radio frequency communication. However, it should be understood that wired or other communication methods are within the scope of the present invention. The headset 20 has a base 24 in which a battery may be stored. In other embodiments, a small vibrating mechanism may be stored within the base 24 to cause it to vibrate upon receipt of an alarm by the device 10. An ear piece 25 is connected to the base by a flexible connection, made flexible by two joints 21, 22. The headset 20 further comprises a microphone 23 extending from the ear piece 25 to pick up a user's voice. This may be transmitted through the headset 20 to another staff member, to the patient, or the like.

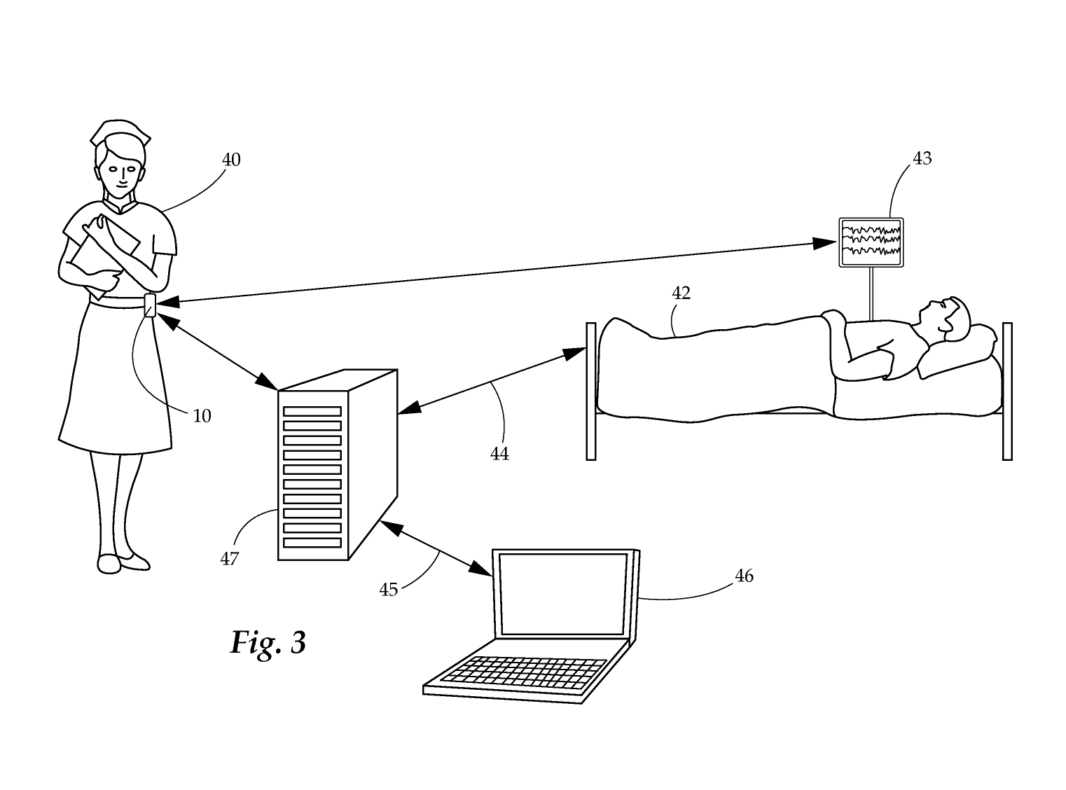

FIG. 3 provides a data flow of an embodiment of the present invention. A user 40 has a belt-mounted device 10 of the present invention attached to their clothing. This device 10 is in electronic wireless communication with a hospital central server 47. This server 47 stores patient information and records, room information, user 40 logs and assignments, and may also track treatment regimens, alarms, and the like.

This server is also in communication 45 with an operations computer 46. The operations computer 46 may operate as a terminal or similar access point for hospital staff to access information stored on the server 47.

Further still, the centralized server 47 may be in communication 44 with the patient's room 42 and patient's medical alerting devices 43. In addition, in some embodiments, the device 10 of the user 40 may be in direct electronic wireless communication with the patient alerting device 43 as well.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A medical patient monitoring system comprising:
a computerized alerting device comprising a processor, a memory, a vibrating mechanism, a touch-screen display, and a battery providing power to the device;
a centralized server in wireless communication with the alerting device, the communication between the server and device instructing the alerting device when to alert a user by a non-audible alarm, wherein the alerting is one of a vibrating by the vibrating mechanism and a flashing on the touch-screen display;
a headset in wireless communication with the computerized alerting device, the headset providing audible communication between the user and one of a patient and a hospital staff member;
wherein the touch-screen display is configured to provide a visual alert on at least one of a cardiac monitor alarm, a bed alarm, a chair alarm, a patient call alarm, an elopement alarm, and a nurse reminder alarm, the visual alerts being activated based on a data communicated from the centralized server.

2. The medical patient monitoring system of claim 1 wherein the alerting device further comprises a camera, the camera configured to record a photograph, the device configured to assign a patient information to the photograph, and configured to communicate the photograph and patient information to the centralized server.

3. The medical patient monitoring system of claim 1 wherein the touch-screen display of the device is configured to display a plurality of room numbers assigned to the user, and a next required action for each of the plurality of room numbers; and wherein upon a touching of the touch-screen display of one of the plurality of room numbers, the display provides a detailed description of the next required action.

4. The medical patient monitoring system of claim 1 wherein the device is configured to receive an input from the user, the device further configured to automatically assign the input to the patient to which it applies, and configured to transmit the input and patient information to the centralized server.

5. The medical patient monitoring system of claim 1 wherein the device is in electronic communication with a patient monitor, the patient monitor capable of activating the non-audible alarm.

6. The medical patient monitoring system of claim 1 wherein the headset further comprises a vibrating mechanism.

7. The medical patient monitoring system of claim 1 wherein the device and the headset are waterproof.

8. The medical patient monitoring system of claim 1 wherein the device and the headset comprise an anti-microbial coating on their outer surfaces.

9. The medical patient monitoring system of claim 1 wherein the device and the headset are washable.

10. A method of using the medical patient monitoring system of claim 1 comprising the steps of:
attaching the alerting device to a garment worn by the user;
inputting a user ID to the device to identify the user;
communicating to the centralized server by the device based on the user ID of the user;
transmitting, by the centralized server to the device, data comprising a plurality of rooms assigned to the user and a plurality of assignments for each room;
providing an alert by the alerting device, the alert being at least one of a flashing by the display, and a vibrating by the vibrating mechanism;
receiving an input from a user to the alerting device confirming that the action alerted by the alerting device has been performed;
transmitting, to the centralized server by the alerting device, a confirmation that the action alerted has been performed after the input is received by the alerting device.

11. The method of claim 10 further comprising the steps of:
activating a camera of the alerting device by the user;
recording a photograph with the camera of the alerting device;
assigning the photograph to a patient file by the alerting device; and
transmitting the photograph and assigned patient file to the centralized server by the alerting device.

12. The method of claim 11 further comprising the steps of:
activating the camera of the alerting device;
scanning a barcode of a medication with the alerting device camera;
assigning the scanned barcode to a patient file by the alerting device;
assigning a timestamp to the scanned barcode by the alerting device; and
transmitting the scanned barcode, timestamp, and assigned patient file to the centralized server.

13. The method of claim 10 further comprising the steps of:
activating a direct input mode of the alerting device;
receiving an input from the user regarding a patient, the receiving being at least one of receiving a typed input on the touch screen, or receiving a spoken input, the spoken input being converted to a text by the processor of the alerting device;
assigning the input to the patient to which it pertains; and
transmitting the input and patient assignment to the centralized server.

14. The method of claim 11 further comprising the steps of:
activating a direct communication feature of the alerting device, the direct communication feature allowing verbal communication with a patient, the communication comprising the steps of:
receiving an audio from the user by the headset;
transmitting a signal based on the received audio from the headset to the alerting device;
transmitting the signal based on the received audio from the alerting device to a speaker in a room of the patient;
receiving an audio from the patient by a microphone in a room of the patient, the microphone generating a second signal;
receiving the second signal by the alerting device; and
transmitting the second signal to the headset.

15. The method of claim 14 further comprising the step of providing an audible alarm by the alerting device in the event that the non-audible alarm is not answered within a determined period of time.

16. The method of claim 15 further comprising the step of displaying one of a plurality of flashing icons by the touch screen display, each of the plurality of flashing icons associated with one of a plurality of possible monitors relating to the patient.

17. The method of claim 16 further comprising the step of receiving an alert of one of a plurality of monitors relating to the patient by direct wireless communication between the alerting device and the one of the plurality of monitors.

18. The method of claim 16 further comprising the step of receiving an alert of one of a plurality of monitors relating to the patient by direct wireless communication between the alerting device and the centralized server.

19. The method of claim 18 wherein the step of accessing the patient file comprises automatically refreshing the patient file by the centralized server after receiving an input from the alerting device.

20. The method of claim 12 further comprising the steps of:
scanning a patient barcode with the alerting device camera;
associating the patient barcode with the patient file;
transmitting, from the alerting device to the central server, the scanned patient barcode;
recording, by the centralized server, a bill to the patient file based on a cost of the medication scanned, the cost information being stored on the centralized server;
performing an allergy and interaction check based on the patient file and scanned medication by the centralized server, wherein the centralized server compares the medicine to a list of medicines that the patient file identifies as being a potential allergy risk or interaction risk; and
transmitting an emergency alert signal to the alerting device instructing the user not to administer the medication scanned.
